(19) United States
(12) Patent Application Publication
(10) Pub. No.: US 2024/0203103 A1
(43) Pub. Date: Jun. 20, 2024

(54) METHOD FOR TRAINING MODEL, ELECTRONIC DEVICE AND STORAGE MEDIUM

(71) Applicant: MaShang Consumer Finance Co., Ltd., Chongqing (CN)

(72) Inventors: Yongchun Lv, Chongqing (CN); Hui Zhu, Chongqing (CN); Xunyi Zhou, Chongqing (CN); Ning Jiang, Chongqing (CN); Haiying Wu, Chongqing (CN)

(21) Appl. No.: 18/591,205

(22) Filed: Feb. 29, 2024

Related U.S. Application Data
(63) Continuation-in-part of application No. PCT/CN2023/102430, filed on Jun. 26, 2023.

(30) Foreign Application Priority Data
Jul. 19, 2022 (CN) 202210872051.8

(51) Int. Cl. G06V 10/774; G06V 10/764; G06V 10/776

(52) U.S. Cl. CPC G06V 10/7753; G06V 10/764; G06V 10/776

(57) ABSTRACT

The present application discloses a method for training a model, an electronic device and a storage medium. The method includes obtaining an image set used for training a model and discriminating the labeled image and the unlabeled image by a target sub-model of the model and determining first classification reference information of the labeled image and first classification reference information of the unlabeled image. The method further includes discriminating the unlabeled image by a non-target sub-model of the model, and determining second classification reference information of the unlabeled image and determining a classification loss of the target sub-model based on the first classification reference information of the labeled image, the category label of the labeled image, and the second classification reference information of the unlabeled image and tuning a model parameter of the model according to the classification loss.

The present application claims the priority to Chinese patent application with application No. 202210872051.8, filed on Jul. 19, 2022, entitled “TRAINING METHOD OF IMAGE CLASSIFICATION MODEL, IMAGE CLASSIFICATION METHOD, AND RELATED DEVICE”, the content of the present application is incorporated herein by reference.

### FIELD

The present application relates to the field of artificial intelligence technology, and specifically to a method for training model, an electronic device and storage medium.

### BACKGROUND

Semi-Supervised Learning (SSL) is a key issue in the field of pattern recognition and machine learning. It is a learning method that combines supervised learning and unsupervised learning. In recent years, semi-supervised learning has been widely used in fields such as image classification.

### BRIEF DESCRIPTION OF THE DRAWINGS

The drawings described here are used to provide a further understanding of the present application and constitute a part of the present application. The illustrative embodiments of the present application and their descriptions are used to describe the present application and do not constitute an improper limitation of the present application. In the drawings:

FIG. 1 is a schematic diagram of a flowchart of a method for training an image classification model provided by an embodiment of the present application.

FIG. 2 is a schematic diagram of a flowchart of a method for training an image classification model provided by another embodiment of the present application.

FIG. 3 is a schematic diagram of a flowchart of an image classification method provided by another embodiment of the present application.

FIG. 4 is a schematic diagram of a structural of a device for training an image classification model provided by an embodiment of the present application.

FIG. 5 is a schematic diagram of a structural of an image classifying device provided by an embodiment of the present application.

FIG. 6 is a schematic diagram of a structural of an electronic device provided by an embodiment of the present application.

### DESCRIPTION

In order to enable those in the art to better understand the technical solutions in the embodiments of the present application, the technical solutions of the present application will be clearly and completely described below with reference to specific embodiments of the present application and corresponding drawings. Obviously, the described embodiments are only some of the embodiments of the present application, rather than all of the embodiments. Based on the embodiments in this application, all other embodiments obtained by those skilled in the art without making creative efforts fall within the scope of protection of this application.

The terms “first”, “second”, etc. in specification and claims are used to distinguish similar objects and are not used to describe a specific order or sequence. It is to be understood that data so used are interchangeable under appropriate circumstances so that embodiments of the present application can be practiced in sequences other than those illustrated or described herein. In addition, “and/or” in the specification and claims indicates at least one of the two objects, and the character “/” generally indicates that the related objects are in an “or” relationship.

The existing method for training an image classification model uses a pre-trained teacher network to generate a pseudo-label for a sample image, and then performs semi-supervised learning through a student network by using the sample image with the pseudo-label and finally forms the image classification model. However, since the pseudo-labels are completely generated by the conversion of the information learned from the sample images by the teacher network, it is not conducive for the student network to fully mine and utilize the information of the sample images, especially in an early stage of training process, a confidence of the pseudo-label generated by the teacher network is not high, which leads to the poor training effect of the image classification model, and then affects the accuracy and stability for classifying the image classification finally.

In view of this, an embodiment of the present application provides a method for training the image classification model. Under a semi-supervised learning framework, a one-way teacher-student relationship between each sub-model of the model is improved to a mutual teacher-student relationship. Using the information learned by one sub-model from the sample images, to provide pseudo-labels for semi-supervised learning for another sub-model, so that each sub-model can learn from each other and teach each other, thereby making the information of the sample images can be fully mined and utilized, thereby improving the training effect of the model, and obtaining a more accurate and reliable model.

The embodiment of the present application also provides a method for classifying images, which can accurately discriminate the images by using the trained model.

It should be understood that both the method for training the model and the method for classifying the images provided by the embodiments of the present application can be executed by an electronic device or software installed in the electronic device. The electronic device here may include a terminal device, such as a smartphone, a tablet computer, a laptop computer, a desktop computer, an intelligent voice interaction device, a smart home appliance, a smart watch, a vehicle-mounted terminal, an aircraft, etc. Or the electronic device may also include a server, for example, an independent physical server, or a server cluster or a distributed system composed of multiple physical servers, or a cloud server that provides basic cloud computing services.

The technical solutions provided by each embodiment of the present application will be described in detail below with reference to the accompanying drawings.

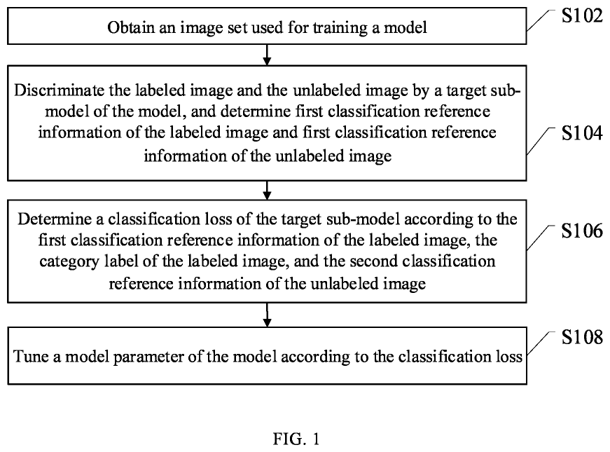

Please refer to FIG. 1, which is a schematic flowchart of a method for training an image classification model provided by one embodiment of the present application. The method may include the following steps:
S102, the electronic device obtains an image set used for training a model.

Among them, the image set includes a labeled image, an unlabeled image, and a category label of the labeled image.

The labeled image refers to an image with a category label, and the unlabeled image refers to an image without a category label. In practical applications, in order to further improve the accuracy for classifying the images of the model, the image set may include multiple labeled images and multiple unlabeled images, and the multiple labeled images may belong to different categories.

Among them, the category label of the labeled image is used to represent a real category to which the labeled image belongs, which can represent the real category to which the content presented in the labeled image belongs specifically. For example, the category to which the labeled image belongs can be a people, an animal, a landscape, etc. For another example, the category to which the labeled image belongs can also be a subcategory of a certain main category, such as for a main category of the people, the category to which the labeled image belongs can be depressed, happy, angry, etc., or the category to which the labeled image belongs may also be a real face, a fake face, etc. For another example, for the category of the animal, the category to which the labeled image belongs may be a cat, a dog, a horse, a mule, etc. In practical applications, the category label of the labeled image may have any appropriate form. For example, the category label of the labeled image may be obtained by one-hot encoding of the real category to which the labeled image belongs or may also be obtained by word embedding of the real category to which the labeled image belongs. The embodiment of the present application does not limit the form of the category label.
S104, the electronic device discriminates the labeled image and the unlabeled image by a target sub-model of the model, and determines first classification reference information of the labeled image and first classification reference information of the unlabeled image.

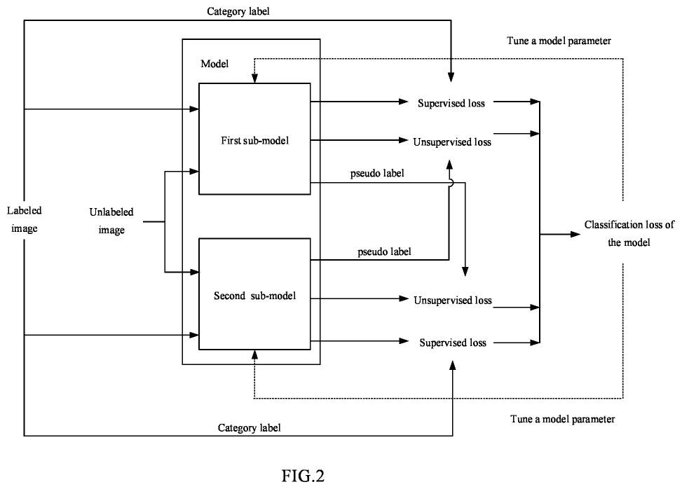

In order to train the model with high accuracy and reliability under a condition that the number of the labeled images is limited, as shown in FIG. 2, the model in the embodiment of the present application may include a first sub-model and a second sub-model, the first sub-model discriminates each image of the image set and determines the first classification reference information, the second sub-model discriminates each image of the image set and determines the first classification reference information. Based on this, the model is finally obtained by using the semi-supervised learning algorithm to train the model. In practical applications, the first sub-model and the second sub-model may have the same network structure, or, in order to simplify the model structure to achieve compression and acceleration of the model, the first sub-model and the second sub-model may also have different network structures. For example, the second sub-model adopts a more streamlined structure than the first sub-model.

In the embodiment of the present application, the target sub-model is the first sub-model or the second sub-model. That is, the first sub-model may be used as the target sub-model to determine the first classification reference information of the labeled image corresponding to the first sub-model through the above mentioned S104, and the second sub-model may be used as the target sub-model to determine the first classification reference information of the unlabeled image corresponding to the second sub-model through the above mentioned S104.

Easy to distinguish, the classification reference information of the labeled image corresponding to the target sub-model is set as the first classification reference information of the labeled image, and the classification reference information of the labeled image corresponds to another sub-model of the model except the target sub-model is set as the second classification reference information of the labeled image. Similarly, the classification reference information of the unlabeled image corresponding to the target sub-model is set as the first classification reference information of the labeled image, and the classification reference information of the unlabeled image corresponds to another sub-model of the model except the target sub-model is set as the second classification reference information of the labeled image. That is, the electronic device discriminates the unlabeled image by a non-target sub-model of the model, and determines the second classification reference information of the unlabeled image.

The first classification reference information of the labeled image may include at least one of the following information: a probability that the labeled image is identified as belonging to each preset category of multiple preset categories, a category to which the labeled image belongs, etc. Similarly, the first classification reference information of the unlabeled image may include at least one of the following information: a probability that the unlabeled image is identified as belonging to each preset category of the multiple preset categories, a category to which the unlabeled image belongs, and so on. For example, multiple preset categories include cats, dogs, horses, and mules. The classification reference information of each image may include the probability that each image is recognized as belonging to a cat, a dog, a horse, or a mule, respectively, and the category to which each image belongs can be the category corresponding to the highest probability among the multiple preset categories.

In order to enable each sub-model of the model to fully understand and learn the image of the image set and improve an expressive ability of the model, the electronic device obtains the image of the image set by augmenting an initial image. That is, before the above mentioned S102, the method for training the model provided by the embodiment of the present application may also include: augmenting the images of an initial image set and obtaining the image set for training the model. So that the image of the image set contains perturbation information. Among them, the initial image set includes an initial unlabeled image and an initial labeled image.

For the initial unlabeled image, the electronic device augments the initial unlabeled image via different augmentation strategies and determines the unlabeled image. The number of the unlabeled images is more than one, and each of the unlabeled images corresponding to one of the different augmentation strategies. Correspondingly, in the above mentioned S104, the first classification reference information of the labeled image may be obtained by discriminating the labeled image through the target sub-model. And the first classification reference information of each unlabeled image may be obtained by discriminating each unlabeled image of the multiple unlabeled images through the target sub-model. Augmenting the initial unlabeled image via different augmentation strategies can be implemented specifically as follows: determining a first unlabeled image by augmenting the initial unlabeled image via a weakly-augmented strategy and determining a second unlabeled image by augmenting the initial unlabeled image via a strongly-augmented strategy. That is, the unlabeled image includes the first unlabeled image and the second unlabeled image, and an augmentation strategy of the first unlabeled image is lighter than an augmentation strategy of the second unlabeled image.

The weakly-augmented strategy may specifically include but is not limited to at least one of the following processing methods: translation, flipping, and so on. The strongly-augmented strategy may include but is not limited to at least one of the following processing methods: occlusion, color transformation, Random Erase, and so on.

It can be understood that since the augmentation strategy of the weakly-augmented strategy is light, that is, the disturbance of the initial unlabeled image is small, it will not distort the first unlabeled image, so that the target sub-model can learn noise of the first unlabeled image according to the obtained accurate first classification reference information, which is conducive to improving the learning effect of the target sub-model. In addition, considering that augmenting the initial unlabeled image only via the weakly-augmented strategy may cause the target sub-model to fall into an overfitting state, the essential features of the first unlabeled image cannot be extracted. The disturbance brought in by the strongly-augmented strategy is relatively strong, which may cause distortion of the first unlabeled image, but it can still retain features sufficient to identify the category of the unlabeled image. After augmenting the initial unlabeled image via the weakly-augmented strategy and the strongly-augmented strategy, the electronic device inputs the initial unlabeled image to the target sub-model, and the target sub-model learns the unlabeled images via different augmentation strategies, which is conducive to improving the learning effect of the target sub-model, and enhancing an expressive ability of the target sub-model.

Optionally, in order to further improve the expressive ability of the target sub-model, before the above mentioned S104, the method for training the model provided by the embodiment of the present application may also include the labeled image by augmenting determining the initial labeled image of the initial image set via the weakly-augmented strategy.
S106, the electronic device determines a classification loss of the target sub-model according to the first classification reference information of the labeled image, the category label of the labeled image, and the second classification reference information of the unlabeled image.

Among them, the second classification reference information of the unlabeled image is obtained by discriminating the unlabeled image by other sub-models of the model except the target sub-model.

In other words, in the above mentioned S106, for the first sub-model, the classification loss of the first sub-model may be determined based on the first classification reference information of the labeled image of the image set, the category label of the labeled image, and the second classification reference information of the unlabeled image of the image set. For the second sub-model, the classification loss of the second sub-model may be determined based on the first classification reference information of the labeled image of the image set, the category label of the labeled image, and the second classification reference information of the unlabeled image of the image set.

In this way, the first sub-model and the second sub-model may use their own learned information to provide guidance to each other, so that the one-way teacher-student relationship between the first sub-model and the second sub-model is changed to a mutual teacher-student relationship, which is conducive to complementary learning and teaching between various sub-models, so that the information of the images of the image set can be fully explored and utilized, which is conducive to improving the training effect of the model.

In an embodiment of the present application, for each sub-model, the classification loss of the sub-model is used to indicate a difference between the classification reference information obtained by discriminating the image inputted to the sub-model and the category represented by the category label of the inputted image.

Considering that the learning task performed by each sub-model according to the input image set is a semi-supervised learning task, which combines a supervised learning task according to the labeled images and corresponding category label of the labeled image and an unsupervised learning task based on the unlabeled image. Each learning task may generate a classification loss, for this reason, the classification loss of the target sub-model can include a supervised loss and a first unsupervised loss of the target sub-model. Among them, the supervised loss of the target sub-model is used to represent the classification loss caused by the target sub-model performing a supervised learning task, and the first unsupervised loss of the target sub-model is used to represent the classification loss caused by the target sub-model performing an unsupervised learning task.

In some embodiments, the supervised loss of the target sub-model can be determined based on the first classification reference information of the labeled image of the image set and the category label of the labeled image. The first unsupervised loss of the target sub-model may be determined based on the first classification reference information and the second classification reference information of the unlabeled image of the image set.

In some embodiments, in order to enable the target sub-model to fully understand and learn the input images and improve the expressive ability of the target sub-model, the unlabeled images are images that are input into the target sub-model after augmenting the initial unlabeled image via different augmentation strategies.

Then the obtained first classification reference information of the unlabeled images includes the first classification reference information of each unlabeled image. Correspondingly, the supervised loss of the target sub-model can be determined based on the first classification reference information of the labeled images of the image set and the category labels of the labeled images. The first unsupervised loss of the target sub-model may be determined based on the first classification reference information and the second classification reference information of the unlabeled images of the image set.

The above-mentioned unlabeled images include the first unlabeled images and the second unlabeled images. An augmentation strategy of the first unlabeled image is lighter than an augmentation strategy of the second unlabeled image. Accordingly, the above-mentioned S106 may specifically include the following steps,
S161, the electronic device generates a first pseudo label of the first unlabeled image according to the second classification reference information of the first unlabeled image.

Since the first unlabeled image without a category label, the electronic device generates the first pseudo label of the first unlabeled image according to the second classification reference information of the first unlabeled image, which means to generate a manually label for the first unlabeled image. The first pseudo label represents a predicted category to which the first unlabeled image belongs, thereby providing guidance for the target sub-model to perform the unsupervised learning task. In practical applications, the first pseudo label of the first unlabeled image may be used to indicate the predicted category to which the first unlabeled image belongs. Of course, the first pseudo label of the first unlabeled image can also be used to indicate a first target object area of the first unlabeled image and a predicted category to which the first target object area belongs. The first target object area refers to the area where the target object of the first unlabeled image recognized by the target sub-model is located. For example, in a scenario of discriminating a human face, the first target object area refers to a face area of the first unlabeled image.

The first classification reference information of the first unlabeled image includes the probability that the first unlabeled image is identified as belonging to each of the multiple preset categories. In this case, in one embodiment, the above S161 can be specifically implemented as: the electronic device determines a preset category corresponding to the maximum probability from the multiple preset categories based on the second classification reference information of the first unlabeled image; in response that the maximum probability corresponding to the preset category is greater than a preset probability threshold, then the electronic device generates the first pseudo label of the first unlabeled image according to the preset category corresponding to the maximum probability.

As shown in FIG. 2, based on the classification reference information output by the second sub-model for the first unlabeled image, the electronic device determines the preset category corresponding to the maximum probability from the multiple preset categories, in response that the maximum probability corresponding to the preset category is greater than the preset probability threshold, then the electronic device generates the pseudo label of the first unlabeled image corresponding to the first sub-model; and based on the classification reference information output by the first sub-model for the first unlabeled image, the electronic device determines the preset category corresponding to the maximum probability from the multiple preset categories, in response that the maximum probability corresponding to the preset category is greater than the preset probability threshold, then the electronic device generates the pseudo label of the first unlabeled image corresponding to the second sub-model.

For example, the pseudo label of the first unlabeled image corresponding to the first sub-model can be determined by the following formula (1), and the pseudo label of the first unlabeled image corresponding to the second sub-model can be determined by the following formula (2):

$${\hat{y}}_{ζ 1}^{u} = ONE\_HOT ( arg max ( {q}_{2} ( {x}_{ζ}^{u} ) ) ) if max ( {q}_{2} ( {x}_{ζ}^{u} ) ) \geq γ \qquad ( 1 )$$

$${\hat{y}}_{ζ 2}^{u} = ONE\_HOT ( arg max ( {q}_{1} ( {x}_{ζ}^{u} ) ) ) if max ( {q}_{1} ( {x}_{ζ}^{u} ) ) \geq γ \qquad ( 2 )$$

Wherein, ŷ_{ζ1}^{u} represents the pseudo label of the ζth first unlabeled image x_{ζ}^{u} of the image set corresponding to the first sub-model, ONE_HOT represents the one-hot encoding, q₂ represents the second sub-model, q₂(x_{ζ}^{u}) represents the classification reference information output by the second sub-model for the first unlabeled imagex_{ζ}^{u}, max(q₂(x_{ζ}^{u})) represents the maximum probability of the classification reference information, arg max (q₂(x_{ζ}^{u})) represents the preset category corresponding to the maximum probability, γ represents the preset probability threshold, ŷ_{ζ2}^{u} represents the pseudo label of the first unlabeled image x_{ζ}^{u} corresponding to the second sub-model, q₁ represents the first sub-model, q₁(x_{ζ}^{u}) represents the classification reference information output by the first sub-model for the first unlabeled image x_{ζ}^{u}, max(q₁ (x_{ζ}^{u})) represents the maximum probability of the classification reference information, arg max (q₁(x_{ζ}^{u})) represents the preset category corresponding to the maximum probability.

Since the augmentation strategy of the first unlabeled image is light, that is, the disturbance for the initial unlabeled image is light, it will not distort the obtained first unlabeled image. In addition, the maximum probability of the classification reference information of the first unlabeled image is greater than the preset probability threshold, then the electronic device generates the pseudo label according to the preset category corresponding to the maximum probability, which can greatly reduce the possibility of adding noise or errors to the pseudo label, thereby ensuring that each sub-model learns the noise of the first unlabeled image on the basis of obtaining accurate discrimination result by the sub-model, which is beneficial to improving the learning effect of each sub-model.

S162, the electronic device determines a first unsupervised loss of the target sub-model according to the first classification reference information of the second unlabeled image and the first pseudo label of the first unlabeled image.

The first unsupervised loss of the first sub-model may be determined based on the classification reference information output by the first sub-model for the second unlabeled image of the image set and the pseudo label of the unlabeled image corresponding to the first sub-model. And the electronic device determines the first unsupervised loss of the second sub-model based on the classification reference information output by the second sub-model for the second unlabeled image corresponding to the unlabeled image of the image set, and the pseudo label of the unlabeled image corresponding to the second sub-model.

In the above mentioned S162, the first unsupervised loss of the target sub-model may be determined according to the first classification reference information of each second unlabeled image of the image set, the first pseudo label of each unlabeled image, and a preset loss function. In practical applications, the preset loss function can be set according to actual needs. For example, the preset loss function includes but not limited to at least one of a cross-entropy loss function, a classification loss function, and a bounding box regression loss function.

For example, for each first unlabeled image of the image set, based on the first classification reference information of the second unlabeled image, the first pseudo label of the first unlabeled image and the preset loss function, the electronic device determines a second unsupervised loss of the first unlabeled image. Furthermore, the electronic device determines the sum of the weights of the second unsupervised loss of each first unlabeled image of the image set as the first unsupervised loss of the target sub-model.

In some embodiments, considering that a confidence of the pseudo label generated in an early stage of the training process is usually not high, which can easily lead to poor training result of the model, the corresponding loss weight may be assigned to the first unlabeled image based on the confidence of the first pseudo label associated with the unlabeled image. For example, assigning higher loss weight to the first unlabeled image with high confidence pseudo label, and assigning lower loss weight to the unlabeled image with low confidence pseudo label, so that the noise of the first pseudo label can be resisted to a certain extent, which is beneficial to improving the training effect of the model.

Before the above mentioned S162, the method for training the model provided by the embodiment of the present application may also includes: determining the loss weight of the first unlabeled image according to the first pseudo label of the first unlabeled image and the second pseudo label of the first unlabeled image. The second pseudo label of the first unlabeled image is generated based on the first classification reference information of the first unlabeled image. The specific generation method is the same as that generating the first pseudo label based on the first unlabeled image.

Correspondingly, in the above mentioned S162, based on the first classification reference information of the second unlabeled image and the first pseudo label of the first unlabeled image, the second unsupervised loss of the first unlabeled image is determined, and based on the loss weight of the first unlabeled image and the first unsupervised loss of the first unlabeled image, the first unsupervised loss of the target sub-model is determined. For example, based on the loss weight of each first unlabeled image of the image set, the second unsupervised loss of each first unlabeled image of the image set can be determined to obtain the first unsupervised loss of the target sub-model by using a weighted summation.

For example, the classification reference information obtained after predicting the same image by different sub-models should theoretically be the same, and the pseudo label of the same image corresponding to different sub-models should also be the same. In this regard, the predicted category indicated by the first pseudo label of the first unlabeled image is compared with the predicted category indicated by the second pseudo label of the first unlabeled image. In response that the two predicted categories are different, the confidence of the two pseudo labels of the first unlabeled image is low, and thus a lower loss weight (i.e., a first preset weight) can be assigned to the first unlabeled image. In response that the two predicted categories are the same, the confidence of the two pseudo labels of the first unlabeled image is higher, and thus a higher loss weight (i.e., a second preset weight) can be assigned to the first unlabeled image.

For example, the first pseudo label of the first unlabeled image may be used to indicate a first target object area of the first unlabeled image and a first predicted category to which the first target object area belongs. The second pseudo label of the first unlabeled image may be used to indicate a second target object area of the first unlabeled image, and a second predicted category to which the second target object area belongs. To ensure that the loss weight assigned to the first unlabeled image better matches the confidence of the two pseudo labels of the first unlabeled image, an intersection ratio between the first target object area and the second target object area can be determined and comparing the first predicted category with the second predicted category and determining a comparison result. Furthermore, based on the intersection ratio and the comparison result, the loss weight of the first unlabeled image is determined.

For example, in response that the intersection ratio is less than or equal to a preset ratio or the comparison result indicates that the first predicted category is different from the second predicted category, then the confidence of the first pseudo label and the confidence of the second pseudo label of the first unlabeled image are low, and then assigning a first preset weight to the first unlabeled image. In response that the intersection ratio is greater than the preset ratio, and the comparison result indicates that the first predicted category is the same as the second predicted category, then the confidence of the first pseudo label and the confidence of the second pseudo label of the first unlabeled image are low, and then assigning a second preset weight to the first unlabeled image, and the second preset weight is greater than the first preset weight.

Correspondingly, in the above mentioned S162, the first unsupervised loss of the target sub-model can be determined through the following formula (3).

$${ℒ}_{{u}_{i}} = \frac{1}{{N}_{u}} ( {\sum }_{b ∈ B ∖ h} {ℒ}_{c l s} ( {x}_{b}^{u} , {\hat{y}}_{b i}^{u} ) + {ℒ}_{reg} ( {x}_{b}^{u} , {\hat{y}}_{b i}^{u} ) + δ {\sum }_{b ∈ h} {ℒ}_{c l s} ( {x}_{b}^{u} , {\hat{y}}_{b i}^{u} ) + {ℒ}_{reg} ( {x}_{b}^{u} , {\hat{y}}_{b i}^{u} ) ) \qquad ( 3 )$$

Among them, [symbol] ᵤ_{ᵢ} represents the first unsupervised loss of the target sub-model, Nᵤ represents the number of first unlabeled images of the image set, B represents the image set, x_{b}^{u} represents the b-th first unlabeled image of the image set, b∈h indicates that the confidence of the first pseudo label and the confidence of the second pseudo label of the b-th first unlabeled image are high, b∈B\h indicates that the confidence of the first pseudo label and the confidence of the second pseudo label of the b-th first unlabeled image are low. L_{cls} represents the classification loss function, [symbol] _{reg} represents the bounding box regression loss function, and ŷ_{bi}^{u} represents the first pseudo label of the first unlabeled image x_{b}^{u}, δ represents the loss weight of the first unlabeled image of the pseudo label with a higher confidence.

It is understandable that since the confidence of the pseudo label generated in the early stage of the training process is usually not high, which can easily lead to poor training result of the model, and the pseudo label generated after discriminating the same image via different sub-models should theoretically be the same. Based on this, based on the pseudo label of each sub-model corresponding to the first unlabeled images, the confidence of the pseudo label can be determined, and then the loss weight can be set for the first unlabeled images, so that the noise of the first pseudo label can be resisted to a certain extent, which is beneficial to improving the training effect of the model.

S163, the electronic device determines a supervised loss of the target sub-model according to the first classification reference information of the labeled image and the category label of the labeled image.

For example, the supervised loss of the target sub-model can be determined through the following formula (4):

$${ℒ}_{{s}_{i}} = \frac{1}{{N}_{l}} {\sum }_{b} {ℒ}_{c l s} ( {x}_{b}^{l} , {y}_{b}^{l} ) + {ℒ}_{reg} ( {x}_{b}^{l} , {y}_{b}^{l} ) \qquad ( 4 )$$

Among them, [symbol] ₛ_{ᵢ} represents the supervised loss of the target sub-model, Nₗ represents the number of labeled images of the image set, x_{b}^{l} represents the l-th labeled image of the image set, y_{b}^{l} represents the category label of the labeled image x_{b}^{l}, [symbol] _{cls} represents the classification loss function, and [symbol] _{reg} represents the bounding box regression loss function.

S164, the electronic device determines a classification loss of the target sub-model according to the first unsupervised loss and the supervised loss of the target sub-model.

For example, the classification loss of the target sub-model is determined as the following formula (5):

$${ℒ}_{i} = {ℒ}_{{s}_{i}} + {λ}_{u} {ℒ}_{{u}_{i}} \qquad ( 5 )$$

Among them, [symbol] ᵢ represents the classification loss of the target sub-model, [symbol] ₛ_{ᵢ} represents the supervised loss of the target sub-model, [symbol] ᵤ_{ᵢ} represents the first unsupervised loss of the target sub-model, and λᵤ represents the loss weight of the first unsupervised loss.

It can be understood that each sub-model of the model performs a semi-supervised learning task based on the image set, which combines the supervised learning tasks based on the labeled images and corresponding category labels and the unsupervised learning task based on the unlabeled images and corresponding pseudo-labels. Each learning task may generate a certain classification loss, for this reason, for each sub-model, the supervised loss of the sub-model is determined based on the classification reference information outputted by the sub-model and the category label of the labeled image, so that the supervised loss can accurately reflect the classification loss generated by the sub-model when performing the supervised learning task. Using the rule that the classification reference information obtained from the same sub-model after inputting the same image that has been processed by different augmentation strategies into the same sub-model is the same in theory. Generating a pseudo label of another sub-model for the first unlabeled image based on the classification reference information of the first unlabeled image with light augmentation strategy corresponding to the sub-model, and then determining the first unsupervised loss of each sub-model by using the pseudo label of each sub-model corresponds to the first unlabeled image and the classification reference information of the second unlabeled image with stronger augmentation strategy corresponding to each sub-model. Not only makes the first unsupervised loss accurately reflect the classification loss generated by the sub-model when performing the unsupervised learning task. It is also conducive to each sub-model using the classification reference information of the first labeled image with light augmentation strategy supervises the classification reference information of the second unlabeled image with stronger augmentation strategy during the unsupervised learning process, which is beneficial to improving the classification accuracy of each sub-model.

The embodiment of the present application here shows a specific implementation method of determining the classification loss of the target sub-model. Of course, it should be understood that the classification loss of the target sub-model can also be determined in other ways, which is not limited in the embodiments of the present application.

S108, the electronic device tunes a model parameter of the model according to the classification loss.

In an embodiment, as shown in FIG. 2, the above mentioned S108 may include the following steps:

S181, the electronic device sums a first classification loss of the first sub-model and a second classification loss of the second sub-model by using a weighted summation and determines the classification loss of the model.

Among them, the classification loss of the model indicates the difference between the classification reference information obtained by discriminating the image inputted to the model and the real category to which the inputted image belongs. For example, the classification loss of the model can be determined by the following formula (6):

$$ℒ = {ℒ}_{1} + {ℒ}_{2} = {ℒ}_{{s}_{1}} + {ℒ}_{{s}_{2}} + {λ}_{u} ( {ℒ}_{{u}_{1}} + {ℒ}_{{u}_{2}} ) \qquad ( 6 )$$

Among them, [symbol] represents the classification loss of the model, [symbol] ₁ represents the first classification loss of the first sub-model, [symbol] ₂ represents the second classification loss of the second sub-model, and [symbol] ₛ_{₁} represents the supervised loss of the first sub-model, [symbol] ᵤ_{₁} represents the first unsupervised loss of the first sub-model, [symbol] ₛ_{₂} represents the supervised loss of the second sub-model, [symbol] ᵤ_{₁} represents the first unsupervised loss of the second sub-model, λᵤ represents the loss weight of the first unsupervised loss.

S182, the electronic device tunes the model parameter of the model according to the classification loss of the model by using a back propagation algorithm.

Among them, the model parameter of the model may include a model parameter of the first sub-model and a model parameter of the second sub-model. For each sub-model, taking a neural network as an example, the model parameter may include but is not limited to the number of neurons in each network layer of the sub-model, a connection relationship between neurons in different network layers, and a weight of connection edge, an offset of a neuron in each network layer, etc.

Since the classification loss of the model can reflect the difference between the classification reference information output by discriminating the image inputted to the model and the real category to which the inputted image belongs. In order to determine a high-accuracy model, the model parameter of the first sub-model is tuned by the classification loss of the first sub-model through the back propagation algorithm, and the model parameter of the second sub-model is tuned by the classification loss of the second sub-model through the back propagation algorithm.

When tuning the model parameter of the first sub-model and the second sub-model respectively by using the back propagation algorithm, a prediction loss caused by each network layer of the first sub-model and the second sub-model can be determined by using the back propagation algorithm based on the classification loss of the image classification model, the current model parameter of the first sub-model and the current model parameter of the second sub-model. Then, with a goal of reducing the classification loss of the model, tuning the relevant parameter of each network layer of the first sub-model and the relevant parameter of each network layer of the second sub-model layer by layer.

The embodiment of the present application discloses a specific implementation of the above mentioned S182. Of course, it should be understood that the above mentioned S182 can also be implemented in other ways, and the embodiment of the present application does not limit this.

It should be noted that the above steps just tune the model parameter of the model for one time. In actual applications, the model parameter of the model may need to be tuned multiple times. Therefore, the above steps S102 to S108 may be repeated multiple times until a preset condition for stop training the model is met. Thus, the model is obtained finally. The preset condition for stop training the model may be that the classification loss of the model is less than a preset loss threshold, or the preset condition may be that the number of tunes the model parameter of the model reaches a preset number, etc. This is not limited in the embodiments of the present application.

Since there may be a certain difference between the classification reference information determined by discriminating the image inputted to the model and the real category to which the inputted image belongs, the classification loss generated by each sub-model will affect the accuracy of the model for classifying. For this reason, the result of summing the classification losses of each sub-model is used as the classification loss of the model, so that the classification loss of the model can more accurately reflect the classification deviation of the model. Then, the classification loss of the model is used to tune the model parameter, which is beneficial to improving the classification accuracy of the model.

The method for training the provided by the embodiment of the present application, under the semi-supervised learning framework, discriminating each image of the image set by using each sub-model of the model separately, and determining multiple classification reference information of each image, and one classification reference information corresponds to a sub-model. Then, each sub-model is used as a target sub-model, and determining the classification loss of the target sub-model based on the classification reference information of the target sub-model corresponding to the labeled image of the image set, the category label of the labeled image, and the classification reference information of another sub-model corresponding to the unlabeled image of the image set. That is, using the information learned by the target sub-model from the image set to provide guidance for another target sub-model, and changing the one-way teacher-student relationship between each target sub-model of the model into the mutual teacher-student relationship. Furthermore, adjusting the model parameter of the model based on the classification loss of each target sub-model of the model can make full use of the mutual teacher-student relationship between each target sub-model, and allow complementary learning and teaching between each sub-models, so that the information of the image set can be fully explored and utilized, thereby improving the training effect of the model and obtaining a more accurate and reliable model.

The above embodiment introduces the method for training the model. Through the above method, the model for different application scenarios can be trained. For different application scenarios, the image set used to train the model and the label of each image of the image set can be selected according to the application scenario. Application scenarios applicable to the method provided by the embodiments of the present application may include, but are not limited to, detecting a target, classifying a facial expression, classifying an animal in the nature, recognizing digital handwritten and other scenarios. Taking the application scenario of classifying an animal in the nature as an example, the category label of the labeled image is used to mark the target object of the labeled image and the category to which the target object belongs, such as cats, dogs, horses, etc. As provided by the above embodiments of the present application, the model trained by the method can detect the area where the target object is located in the image to be processed and identify the category to which the target object belongs.

Based on the method for training the model disclosed in the above embodiments of the present application, the trained model can be applied to any scene that requires discrimination of images. The application process based on the model is described in detail below.

Embodiments of the present application also provide a method for classifying an image by using a model, which can discriminate images to be processed based on the model trained by the above method.

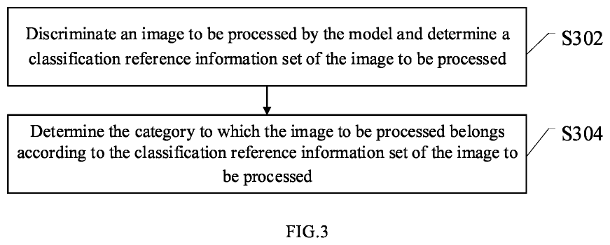

Please refer to FIG. 3, is a schematic diagram of a flowchart of a method for classifying an image provided by another embodiment of the present application. The method may include the following steps:

S302, the electronic device discriminates an image to be processed by the model and determines a classification reference information set of the image to be processed.

Among them, the classification reference information set of the image to be processed includes the first target classification reference information of the image to be processed and the second target classification reference information of the image to be processed. The model includes a first sub-model and a second sub-model. The first sub-model is used to discriminate the image to be processed and determine the first target classification reference information of the image to be processed. The second sub-model is used to discriminate the image to be processed and determine the second target classification reference information of the image to be processed.

S304, the electronic device determines the category to which the image to be processed belongs according to the classification reference information set of the image to be processed.

In some embodiments, the category to which the image to be processed can be determined based on the classification reference information of the image to be processed of any one of the sub-models. For example, the category corresponding to the maximum probability of the first target classification reference information of the image to be processed can be determined as the category to which the image to be processed belongs, or the category corresponding to the maximum probability of the second target classification reference information of the image to be processed can also be determined as the category to which the image to be processed belongs.

In some embodiments, the above classification reference information of the image to be processed can also be combined to determine the category to which the image to be processed belongs. For example, in response that a first category corresponding to the maximum probability of the first target classification reference information of the image to be processed is the same as a second category corresponding to the maximum classification probability of the second target classification reference information of the image to be processed, then the first category can be determined as the category to which the image to be processed belongs. For another example, the category to which the image to be processed belongs can be determined based on an overlap between a first target category set of the first target category reference information of the image to be processed and a second target category set of the second target category reference information of the image to be processed. The first target category set includes categories corresponding to the probabilities exceeding the preset probability threshold of the first target classification reference information, and the second target category set includes categories corresponding to the probabilities exceeding the preset probability of the second target classification reference information, and so on.

The method for classifying an image provided by the embodiments of the present application is based on the semi-supervised learning method and utilizes the mutual teacher-student relationship between each sub-model through complementary learning and teaching between each sub-model. So that the model has high accuracy and reliability. Furthermore, using the to discriminate the image to be processed will help to improve the accuracy and reliability of the results for classifying the image.

The foregoing describes specific embodiments of the specification. Other embodiments are within the scope of the appended claims. In some cases, the actions or steps recited in the claims can be performed in a different order than in the embodiments and still achieve the desired results. Additionally, the processes depicted in the drawings do not necessarily require the specific order as shown, or sequential order, to achieve desirable results. Multitasking and parallel processing are also possible or may be advantageous in certain implementations.

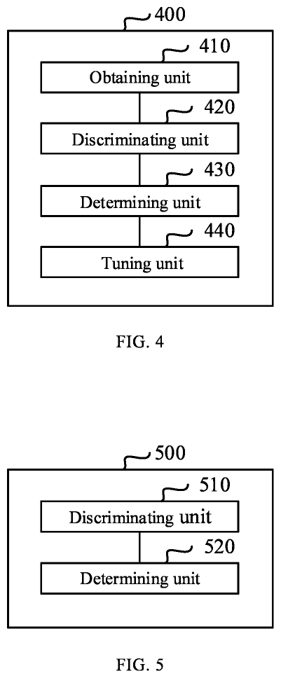

In addition, corresponding to the method for training the model shown in FIG. 1, embodiments of the present application also provide a device for training the model. Please refer to FIG. 4, is a schematic diagram of a structural of a device 400 for training a model provided by an embodiment of the present application. The device 400 includes an obtaining unit 410, used to obtain an image set used for training a model, the image set comprises a labeled image, an unlabeled image and a category label of the labeled image; a discriminating unit 420, used to discriminate the labeled image and the unlabeled image by a target sub-model of the model, and determine first classification reference information of the labeled image and first classification reference information of the unlabeled image, and discriminate the unlabeled image by a non-target sub-model of the model, and determine second classification reference information of the unlabeled image; a determining unit 430, used to a classification loss of the target sub-model based on the first classification reference information of the labeled image, the category label of the labeled image, and the second classification reference information of the unlabeled image; a tuning unit 440, used to tune a model parameter of the model according to the classification loss.

In some embodiments, the obtaining unit is also used to obtain an initial unlabeled image.

The device 400 further includes: an augmenting unit, configured to augment the initial unlabeled image via different augmentation strategies and determining the unlabeled images, wherein the number of the unlabeled images is more than one, and each of the unlabeled images corresponding to one of the different augmentation strategies.

In some embodiments, the unlabeled images include a first unlabeled image and a second unlabeled image, and an augmentation strategy of the first unlabeled image is lighter than an augmentation strategy of the second unlabeled image.

The determining unit determines the classification loss of the target sub-model based on the first classification reference information of the labeled image, the category label of the labeled image, and the second classification reference information of the unlabeled image, including: generating a first pseudo label of the first unlabeled image according to the second classification reference information of the first unlabeled image; determining a first unsupervised loss of the target sub-model according to the first classification reference information of the second unlabeled image and the first pseudo label; determining a supervised loss of the target sub-model according to the first classification reference information of the labeled image and the category label of the labeled image; and determining the classification loss of the target sub-model according to the first unsupervised loss of the target sub-model and the supervised loss of the target sub-model.

In some embodiments, the determining unit is further configured to determine a loss weight of the first unlabeled image according to the first pseudo label and a second pseudo label before determining the first unsupervised loss of the target sub-model according to the first classification reference information of the second unlabeled image and the first pseudo label. Among them, the second pseudo label is generated according to the first classification reference information of the first unlabeled image.

The determining unit determines the supervised loss of the target sub-model according to the first classification reference information of the labeled image and the category label of the labeled image including: determining a second unsupervised loss of the first unlabeled image according to the first classification reference information of the second unlabeled image and the first pseudo label; and determining the first unsupervised loss of the target sub-model according to the loss weight and the second unsupervised loss.

In some embodiments, the first pseudo label of the first unlabeled image is used to indicate a first target object area of the first unlabeled image and a first predicted category to which the first target object area belongs, and the second pseudo label of the first unlabeled image is used to indicate a second target object area of the first unlabeled image and a second predicted category to which the second target object area belongs.

The determining unit determines the loss weight of the first unlabeled image according to the first pseudo label and a second pseudo label including: determining an intersection ratio between the first target object area and the second target object area, and comparing the first predicted category with the second predicted category and determining a comparison result; and determining the loss weight of the first unlabeled image according to the intersection ratio and the comparison result.

In some embodiments, the determining unit determines the loss weight of the first unlabeled image according to the intersection ratio and the comparison result including: in response that the intersection ratio is less than or equal to a preset ratio, or in response that the comparison result indicates that the first predicted category is different from the second predicted category, determining the loss weight of the first unlabeled image as a first preset weight; in response that the intersection ratio is greater than the preset ratio, and in response that the comparison result indicates that the first predicted category is the same as the second predicted category, determining the loss weight of the first unlabeled image as a second preset weight, wherein the second preset weight is greater than the first preset weight.

In some embodiments, the first classification reference information of the first unlabeled image and the second classification reference information of the first unlabeled image both comprise a probability that the first unlabeled image is identified as belonging to each of a plurality of the preset categories.

The determining unit generates the first pseudo label of the first unlabeled image according to the second classification reference information of the first unlabeled image, including: determining a preset category corresponding to a maximum probability from the plurality of preset categories according to the second classification reference information of the first unlabeled image; generating the first pseudo label of the first unlabeled image according to the preset category corresponding to the maximum probability in response that the maximum probability is greater than a preset probability threshold.

In some embodiments, the tuning unit tunes the model parameter of the model according to the classification loss including: summing a first classification loss of the first sub-model and a second classification loss of the second sub-model by using a weighted summation and determining the classification loss of the model; and tuning the model parameter of the model according to the first classification loss and the second classification loss by using a back propagation algorithm.

Obviously, the device for training the image classification model provided by the embodiment of the present application can be used as an execution subject of the method for training the image classification model shown in FIG. 1. For example, step S102 of the method for training the image classification model shown in FIG. 1 can be executed by the obtaining unit of the device for training the image classification model shown in the FIG. 4. Step S104 can be executed by the discriminating unit of the device for training the image classification model. Step S106 can be executed by the determining unit of the device for training the image classification model. Step S108 can be executed by the tuning unit of the device for training the image classification model.

According to another embodiment of the present application, each unit of the device for training the image classification model shown in FIG. 4 can be separately or entirely formed by combining into one or several other units, or formed by some of the units, which can also be further divided into multiple units with smaller functions, which can achieve the same operation without affecting the realization of the technical effects of the embodiments of the present application. The above units are divided based on logical functions. In practical applications, the function of one unit can also be realized by multiple units, or the functions of multiple units can be realized by one unit. In other embodiments of the present application, the device for training the image classification model may also include other units. In practical applications, these functions may also be implemented with the assistance of other units and may be implemented by multiple units in cooperation.

According to another embodiment of the present application, the device for training the image classification model shown in FIG. 4 can be constructed by running a computer program (including program code) capable of executing each step involved in the corresponding method shown in FIG. 1 on a general-purpose computing device of a computer, which includes the processing components and storage components such as a central processing unit, a random access memory, a read-only memory, and so on, to implement the method for training the image classification model in the embodiment of the present application. The computer program can be recorded on, for example, a computer-readable storage medium, and can be reproduced in an electronic device through the computer-readable storage medium and run therein.

The device for training the model provided by the embodiment of the present application, under the semi-supervised learning framework, discriminating each image of the image set by using each sub-model of the model separately, and determining multiple classification reference information of each image, and one classification reference information corresponds to a sub-model. Then, each sub-model is used as a target sub-model, and determining the classification loss of the target sub-model based on the classification reference information of the target sub-model corresponding to the labeled image of the image set, the category label of the labeled image, and the classification reference information of another sub-model corresponding to the unlabeled image of the image set. That is, using the information learned by the target sub-model from the image set to provide guidance for another target sub-model, and changing the one-way teacher-student relationship between each target sub-model of the model into the mutual teacher-student relationship. Furthermore, tuning the model parameter of the model based on the classification loss can make full use of the mutual teacher-student relationship between each target sub-model, and allow complementary learning and teaching between each sub-models, so that the information of the image set can be fully explored and utilized, thereby improving the training effect of the model and obtaining a more accurate and reliable model.

In addition, method for classifying image as shown in FIG. 3, the embodiment of the present application also provides an image classification device. Please refer to FIG. 5, which is a schematic structural diagram of an image classification device 500 provided in an embodiment of the present application. The device 500 includes: a discriminating unit 510, configured to discriminate an image to be processed by the model and determines a classification reference information set of the image to be processed the classification reference information set of the image to be processed includes the first target classification reference information of the image to be processed and the second target classification reference information of the image to be processed. The model includes a first sub-model and a second sub-model. The first sub-model is used to discriminate the image to be processed and determine the first target classification reference information of the image to be processed. The second sub-model is used to discriminate the image to be processed and determine the second target classification reference information of the image to be processed. The determining unit 520 is used to determine the category to which the image to be processed belongs according to the classification reference information set of the image to be processed.

Obviously, the image classification device provided by the embodiment of the present application can be used as an execution subject of the image classification method shown in FIG. 3. For example, step S302 of the image classification method shown in FIG. 3 can be executed by the discriminating unit of the image classification device shown in the FIG. 5. Step S304 can be executed by the determining unit of the image classification device.

According to another embodiment of the present application, each unit of the image classification device shown in FIG. 5 can be separately or entirely formed by combining into one or several other units, or formed by some of the units, which can also be further divided into multiple units with smaller functions, which can achieve the same operation without affecting the realization of the technical effects of the embodiments of the present application. The above units are divided based on logical functions. In practical applications, the function of one unit can also be realized by multiple units, or the functions of multiple units can be realized by one unit. In other embodiments of the present application, the device for training the image classification model may also include other units. In practical applications, these functions may also be implemented with the assistance of other units and may be implemented by multiple units in cooperation.

According to another embodiment of the present application, The image classification device shown in FIG. 5 can be constructed by running a computer program (including program code) capable of executing each step involved in the corresponding method shown in FIG. 3 on a general-purpose computing device of a computer, which includes the processing components and storage components such as a central processing unit, a random access memory, a read-only memory, and so on, to implement the method for training the image classification model in the embodiment of the present application. The computer program can be recorded on, for example, a computer-readable storage medium, and can be reproduced in an electronic device through the computer-readable storage medium and run therein.

The image classification device provided by the embodiments of the present application is based on the semi-supervised learning method and utilizes the mutual teacher-student relationship between each sub-model through complementary learning and teaching between each sub-model. So that the model has high accuracy and reliability. Furthermore, using the model to discriminate the image to be processed will help to improve the accuracy and reliability of the results for classifying the images.

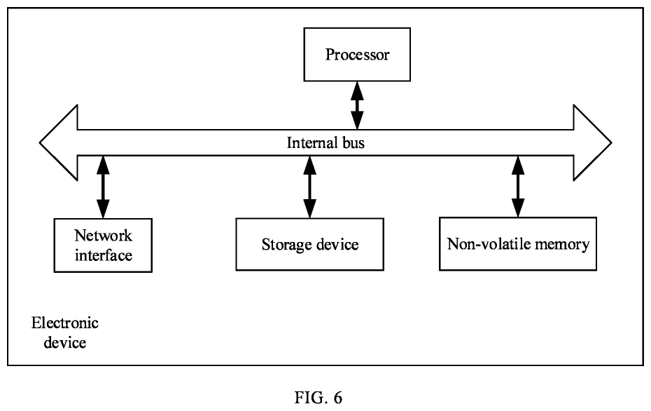

FIG. 6 is a schematic structural diagram of an electronic device according to an embodiment of the present application. Please refer to FIG. 6. for the hardware, the electronic device includes a processor and optionally an internal bus, a network interface, and a storage device. Among them, the storage device may include an internal storage, such as high-speed random-access memory, or may also include a non-volatile memory, such as at least one disk memory. Of course, the electronic device may also include other hardware required by the business.

The processor, the network interface and the storage device can be connected to each other through the internal bus, which can be an industry standard architecture (ISA) bus, a peripheral component interconnect (PCI) standard bus or an extended industry standard architecture (EISA) bus, etc. The bus can be distinguished as an address bus, a data bus, a control bus, etc. For ease of presentation, only one bidirectional arrow is used in FIG. 6, but it does not mean that there is only one bus or one type of bus.

The storage device, used to store programs. Specifically, a program may include program code including computer operating instructions. The storage device may include an internal memory and a non-volatile memory and provides instructions and data to the processor.

The processor reads the corresponding computer program from the non-volatile memory into the storage device and then runs it, forming the device for training the image classification model by logical. The processor executes the program stored in the storage device and is specifically used to perform the following operations: an image set used for training a model, the image set comprises a labeled image, an unlabeled image and a category label of the labeled image; discriminate the labeled image and the unlabeled image by a target sub-model of the model, and determine first classification reference information of the labeled image and first classification reference information of the unlabeled image; discriminate the unlabeled image by a non-target sub-model of the model, and determine second classification reference information of the unlabeled image; and determine a classification loss of the target sub-model based on the first classification reference information of the labeled image, the category label of the labeled image, and the second classification reference information of the unlabeled image; and tune a model parameter of the model according to the classification loss.

Alternatively, the processor reads the corresponding computer program from the non-volatile memory into the storage device and then runs it to form an image classification device by logical. The processor executes the program stored in the storage device and is specifically used to perform the following operations: discriminating an image to be processed by the model and determining a classification reference information set of the image to be processed, and determining the category to which the image to be processed belongs according to the classification reference information set of the image to be processed. The classification reference information set of the image to be processed includes the first target classification reference information of the image to be processed and the second target classification reference information of the image to be processed. The model includes a first sub-model and a second sub-model. The first sub-model is used to discriminate the image to be processed and determine the first target classification reference information of the image to be processed. The second sub-model is used to discriminate the image to be processed and determine the second target classification reference information of the image to be processed.

The method performed by the device for training the image classification model presented in the embodiment shown in FIG. 1 of the present application or the method performed by the image classification device presented in the embodiment shown in FIG. 3 of the present application can be applied to the processor or implemented by the processor. The processor may be an integrated circuit chip that has signal processing capabilities. During the implementation process, each step of the above method can be completed by instructions in the form of hardware integrated logic circuits or software in the processor. The above-mentioned processor can be a general-purpose processor, including a central processing unit, a network processor, etc.; it can also be a digital signal processor, an application specific integrated circuit, a field-programmable gate array or other programmable logic devices, a discrete gate or a transistor logic device, and discrete hardware components. Each method, step and logical block diagram presented in the embodiment of this application can be implemented or executed. A general-purpose processor may be a micro-processor, or the processor may be any conventional processor, etc. The steps of the method presented in conjunction with the embodiments of the present application can be directly implemented by a hardware decoding processor or executed by a combination of hardware and software modules in the decoding processor. The software module can be located in a random-access memory, a flash memory, a read-only memory, a programmable read-only memory or an electrically erasable programmable memory, registers and other mature storage media in this field. The storage medium is located in the storage device, and the processor reads the information in the storage device and completes the steps of the above method in combination with its hardware.

The electronic device can also perform the method in FIG. 1 and implement the functions of the device for training the image classification model in the embodiments shown in FIG. 1 and FIG. 2. Alternatively, the electronic device can also perform the method in FIG. 3 and implement the image classification device. The functions of the embodiment shown in FIG. 3 will not be described again in the embodiment of this application.

Of course, except for the implementation of software, the electronic device of the present application does not exclude other implementations, such as logic devices or a combination of software and hardware, etc. That is to say, the execution subject of the following processing flow is not limited to each logical unit. It can also be hardware or logic devices.

Embodiments of the present application also provide a computer-readable storage medium that stores one or more programs, and the one or more programs include instructions that, when executed by a portable electronic device including multiple application programs, enable the portable electronic device perform the method of the embodiment shown in FIG. 1, and is specifically used to perform the following operations: obtaining an image set used for training a model, the image set comprises a labeled image, an unlabeled image and a category label of the labeled image; discriminating the labeled image and the unlabeled image by a target sub-model of the model, and determining first classification reference information of the labeled image and first classification reference information of the unlabeled image; discriminating the unlabeled image by a non-target sub-model of the model, and determining second classification reference information of the unlabeled image; determining a classification loss of the target sub-model based on the first classification reference information of the labeled image, the category label of the labeled image, and the second classification reference information of the unlabeled image; and tuning a model parameter of the model according to the classification loss.

Alternatively, the computer-readable storage medium stores one or more programs, and the one or more programs include instructions that, when executed by a portable electronic device including a plurality of application programs, enable the portable electronic device to perform the steps shown in FIG. 3. The method of the embodiment is specifically used to perform the following operations: discriminating an image to be processed by the model and determining a classification reference information set of the image to be processed, and determining the category to which the image to be processed belongs according to the classification reference information set of the image to be processed. The classification reference information set of the image to be processed includes the first target classification reference information of the image to be processed and the second target classification reference information of the image to be processed. The model includes a first sub-model and a second sub-model. The first sub-model is used to discriminate the image to be processed and determine the first target classification reference information of the image to be processed. The second sub-model is used to discriminate the image to be processed and determine the second target classification reference information of the image to be processed.

In short, the above descriptions are only preferred embodiments of the present application and are not intended to limit the protection scope of the present application. Any modifications, equivalent replacements, improvements, etc. made within the spirit and principles of the present application shall be included in the protection scope of the present application.

The systems, devices, modules or units described in the above embodiments may be implemented by computer chips or entities, or by products with certain functions. A typical implementation device is a computer. Specifically, the computer may be, for example, a personal computer, a laptop computer, a cellular phone, a camera phone, a smartphone, a personal digital assistant, a media player, a navigation device, an email device, a game console, a tablet computer, a wearable device, or a combination of any of these devices.

Computer-readable media includes both persistent and non-volatile, removable and non-removable media that can be implemented by any method or technology for storage of information. Information may be computer-readable instructions, data structures, modules of programs, or other data. Example of computer storage media include, but is not limited to, a phase change memory, a static random access memory, a dynamic random access memory, other type of random access memory, and a read-only memory, an electrically erasable programmable read-only memory, a flash memory or other memory technology, a compact disc read-only memory, a digital versatile disc or other optical storage, a magnetic tape cassette, a tape disk storage or other magnetic storage device or any other non-transmission medium can be used to store information that can be accessed by a computing device. As defined in the present application, a computer-readable media does not include a transitory media, such as modulated data signals and carrier waves.

It should also be noted that the terms “comprise,” “include,” or any other variation thereof are intended to cover a non-exclusive inclusion, such that a process, method, article, or apparatus that includes a list of elements not only includes those elements, but also includes other elements are not expressly listed or are inherent to the process, method, article or equipment. Without further limitation, an element defined by the statement “include a . . . ” does not exclude the presence of additional identical elements in a process, a method, an article, or a device that includes the stated element.

Each embodiment in the specification is described in a progressive manner. The same and similar parts between the various embodiments can be referred to each other. Each embodiment focuses on its differences from other embodiments. For the system embodiment, since it is basically similar to the method embodiment, the description is relatively simple. For relevant details, please refer to the partial description of the method embodiment.

1. A method for training a model, comprising:
obtaining an image set used for training a model, the image set comprises a labeled image, an unlabeled image and a category label of the labeled image;
discriminating the labeled image and the unlabeled image by a target sub-model of the model, and determining first classification reference information of the labeled image and first classification reference information of the unlabeled image;
discriminating the unlabeled image by a non-target sub-model of the model, and determining second classification reference information of the unlabeled image;
determining a classification loss of the target sub-model based on the first classification reference information of the labeled image, the category label of the labeled image, and the second classification reference information of the unlabeled image; and
tuning a model parameter of the model according to the classification loss.

2. The method according to claim 1, wherein the method further comprises:
obtaining an initial unlabeled image; and
augmenting the initial unlabeled image via different augmentation strategies and determining the unlabeled images, wherein the number of the unlabeled images is more than one, and each of the unlabeled images corresponding to one of the different augmentation strategies.

3. The method according to claim 2, wherein the unlabeled images comprise a first unlabeled image and a second unlabeled image, and an augmentation strategy of the first unlabeled image is lighter than an augmentation strategy of the second unlabeled image;
wherein determining the classification loss of the target sub-model based on the first classification reference information of the labeled image, the category label of the labeled image, and the second classification reference information of the unlabeled image comprises:
generating a first pseudo label of the first unlabeled image according to the second classification reference information of the first unlabeled image;
determining a first unsupervised loss of the target sub-model according to the first classification reference information of the second unlabeled image and the first pseudo label;
determining a supervised loss of the target sub-model according to the first classification reference information of the labeled image and the category label of the labeled image; and
determining the classification loss of the target sub-model according to the first unsupervised loss of the target sub-model and the supervised loss of the target sub-model.

4. The method according to claim 3, wherein before determining the first unsupervised loss of the target sub-model according to the first classification reference information of the second unlabeled image and the first pseudo label, the method further comprises:
determining a loss weight of the first unlabeled image according to the first pseudo label and a second pseudo label, wherein the second pseudo label is generated according to the first classification reference information of the first unlabeled image;
wherein determining the supervised loss of the target sub-model according to the first classification reference information of the labeled image and the category label of the labeled image comprises:
determining a second unsupervised loss of the first unlabeled image according to the first classification reference information of the second unlabeled image and the first pseudo label; and
determining the first unsupervised loss of the target sub-model according to the loss weight and the second unsupervised loss.

5. The method according to claim 4, wherein the first pseudo label of the first unlabeled image is used to indicate a first target object area of the first unlabeled image and a first predicted category to which the first target object area belongs, the second pseudo label of the first unlabeled image is used to indicate a second target object area of the first unlabeled image and a second predicted category to which the second target object area belongs;
wherein determining the loss weight of the first unlabeled image according to the first pseudo label and a second pseudo label comprises:
determining an intersection ratio between the first target object area and the second target object area, and comparing the first predicted category with the second predicted category and determining a comparison result; and
determining the loss weight of the first unlabeled image according to the intersection ratio and the comparison result.

6. The method according to claim 5, wherein determining the loss weight of the first unlabeled image according to the intersection ratio and the comparison result comprises:
in response that the intersection ratio is less than or equal to a preset ratio, or in response that the comparison result indicates that the first predicted category is different from the second predicted category, determining the loss weight of the first unlabeled image as a first preset weight;
in response that the intersection ratio is greater than the preset ratio, and in response that the comparison result indicates that the first predicted category is the same as the second predicted category, determining the loss weight of the first unlabeled image as a second preset weight, wherein the second preset weight is greater than the first preset weight.

7. The method according to claim 3, wherein the first classification reference information of the first unlabeled image and the second classification reference information of the first unlabeled image both comprise a probability that the first unlabeled image is identified as belonging to each of a plurality of the preset categories;
wherein generating the first pseudo label of the first unlabeled image according to the second classification reference information of the first unlabeled image comprises:
determining a preset category corresponding to a maximum probability from the plurality of preset categories according to the second classification reference information of the first unlabeled image; and
generating the first pseudo label of the first unlabeled image according to the preset category corresponding to the maximum probability in response that the maximum probability is greater than a preset probability threshold.

8. The method according to claim 1, wherein the target sub-model comprises a first sub-model and a second sub-model,
wherein tuning the model parameter of the model according to the classification loss comprises:
summing a first classification loss of the first sub-model and a second classification loss of the second sub-model by using a weighted summation and determining the classification loss of the model; and
tuning the model parameter of the model according to the first classification loss and the second classification loss by using a back propagation algorithm.

9. An electronic device comprising:
a storage device;
at least one processor; and
the storage device storing one or more programs, which when executed by the at least one processor, cause the at least one processor to:
obtain an image set used for training a model, the image set comprises a labeled image, an unlabeled image and a category label of the labeled image;
discriminate the labeled image and the unlabeled image by a target sub-model of the model, and determine first classification reference information of the labeled image and first classification reference information of the unlabeled image;
discriminate the unlabeled image by a non-target sub-model of the model, and determine second classification reference information of the unlabeled image;
determine a classification loss of the target sub-model based on the first classification reference information of the labeled image, the category label of the labeled image, and the second classification reference information of the unlabeled image; and
tune a model parameter of the model according to the classification loss.

10. The electronic device according to claim 9, wherein the at least one processor is further caused to:
obtain an initial unlabeled image; and
augment the initial unlabeled image via different augmentation strategies and determine the unlabeled images, wherein the number of the unlabeled images is more than one, and each of the unlabeled images corresponding to one of the different augmentation strategies.

11. The electronic device according to claim 10, wherein the unlabeled images comprise a first unlabeled image and a second unlabeled image, and an augmentation strategy of the first unlabeled image is lighter than an augmentation strategy of the second unlabeled image;
wherein the at least one processor determines the classification loss of the target sub-model based on the first classification reference information of the labeled image, the category label of the labeled image, and the second classification reference information of the unlabeled image, by:
generating a first pseudo label of the first unlabeled image according to the second classification reference information of the first unlabeled image;
determining a first unsupervised loss of the target sub-model according to the first classification reference information of the second unlabeled image and the first pseudo label;
determining a supervised loss of the target sub-model according to the first classification reference information of the labeled image and the category label of the labeled image; and
determining the classification loss of the target sub-model according to the first unsupervised loss of the target sub-model and the supervised loss of the target sub-model.

12. The electronic device according to claim 11, wherein before determining the first unsupervised loss of the target sub-model according to the first classification reference information of the second unlabeled image and the first pseudo label, the at least one processor is further caused to:
determine a loss weight of the first unlabeled image according to the first pseudo label and a second pseudo label, wherein the second pseudo label is generated according to the first classification reference information of the first unlabeled image;
wherein the at least one processor determines the supervised loss of the target sub-model according to the first classification reference information of the labeled image and the category label of the labeled image, by:
determining a second unsupervised loss of the first unlabeled image according to the first classification reference information of the second unlabeled image and the first pseudo label; and
determining the first unsupervised loss of the target sub-model according to the loss weight and the second unsupervised loss.

13. The electronic device according to claim 12, wherein the first pseudo label of the first unlabeled image is used to indicate a first target object area of the first unlabeled image and a first predicted category to which the first target object area belongs, the second pseudo label of the first unlabeled image is used to indicate a second target object area of the first unlabeled image and a second predicted category to which the second target object area belongs;
wherein the at least one processor determines the loss weight of the first unlabeled image according to the first pseudo label and a second pseudo label, by:
determining an intersection ratio between the first target object area and the second target object area, and comparing the first predicted category with the second predicted category and determining a comparison result; and
determining the loss weight of the first unlabeled image according to the intersection ratio and the comparison result.

14. The electronic device according to claim 11, wherein the at least one processor determines the loss weight of the first unlabeled image according to the intersection ratio and the comparison result, by:
determining the loss weight of the first unlabeled image as a first preset weight, in response that the intersection ratio is less than or equal to a preset ratio, or in response that the comparison result indicates that the first predicted category is different from the second predicted category; and
determining the loss weight of the first unlabeled image as a second preset weight, in response that the intersection ratio is greater than the preset ratio, and in response that the comparison result indicates that the first predicted category is the same as the second predicted category, wherein the second preset weight is greater than the first preset weight.

15. The electronic device according to claim 11, wherein the first classification reference information of the first unlabeled image and the second classification reference information of the first unlabeled image both comprise a probability that the first unlabeled image is identified as belonging to each of a plurality of the preset categories;
wherein the at least one processor generates the first pseudo label of the first unlabeled image according to the second classification reference information of the first unlabeled image, by:
determining a preset category corresponding to a maximum probability from the plurality of preset categories according to the second classification reference information of the first unlabeled image; and
generating the first pseudo label of the first unlabeled image according to the preset category corresponding to the maximum probability in response that the maximum probability is greater than a preset probability threshold.

16. The electronic device according to claim 9, wherein the target sub-model comprises a first sub-model and a second sub-model,
wherein the at least one processor tunes the model parameter of the model according to the classification loss, by:
summing a first classification loss of the first sub-model and a second classification loss of the second sub-model by using a weighted summation and determining the classification loss of the model; and
tuning the model parameter of the model according to the first classification loss and the second classification loss by using a back propagation algorithm.

17. A non-transitory storage medium having instructions stored thereon, when the instructions are executed by a processor of an electronic device, the processor is caused to perform a method for training a model, wherein the method comprises:
obtaining an image set used for training a model, the image set comprises a labeled image, an unlabeled image and a category label of the labeled image;
discriminating the labeled image and the unlabeled image by a target sub-model of the model, and determining first classification reference information of the labeled image and first classification reference information of the unlabeled image;
discriminating the unlabeled image by a non-target sub-model of the model, and determining second classification reference information of the unlabeled image;
determining a classification loss of the target sub-model based on the first classification reference information of the labeled image, the category label of the labeled image, and the second classification reference information of the unlabeled image; and
tuning a model parameter of the model according to the classification loss.

18. The non-transitory storage medium according to claim 17, wherein the method further comprises:
obtaining an initial unlabeled image; and
augmenting the initial unlabeled image via different augmentation strategies and determining the unlabeled images, wherein the number of the unlabeled images is more than one, and each of the unlabeled images corresponding to one of the different augmentation strategies.

19. The non-transitory storage medium according to claim 18, wherein the unlabeled images comprise a first unlabeled image and a second unlabeled image, and an augmentation strategy of the first unlabeled image is lighter than an augmentation strategy of the second unlabeled image;
wherein determining the classification loss of the target sub-model based on the first classification reference information of the labeled image, the category label of the labeled image, and the second classification reference information of the unlabeled image comprises:
generating a first pseudo label of the first unlabeled image according to the second classification reference information of the first unlabeled image;
determining a first unsupervised loss of the target sub-model according to the first classification reference information of the second unlabeled image and the first pseudo label;
determining a supervised loss of the target sub-model according to the first classification reference information of the labeled image and the category label of the labeled image; and
determining the classification loss of the target sub-model according to the first unsupervised loss of the target sub-model and the supervised loss of the target sub-model.

20. The non-transitory storage medium according to claim 19, wherein before determining the first unsupervised loss of the target sub-model according to the first classification reference information of the second unlabeled image and the first pseudo label, the method further comprises:
determining a loss weight of the first unlabeled image according to the first pseudo label and a second pseudo label, wherein the second pseudo label is generated according to the first classification reference information of the first unlabeled image;
wherein determining the supervised loss of the target sub-model according to the first classification reference information of the labeled image and the category label of the labeled image comprises:
determining a second unsupervised loss of the first unlabeled image according to the first classification reference information of the second unlabeled image and the first pseudo label; and
determining the first unsupervised loss of the target sub-model according to the loss weight and the second unsupervised loss.
